(19) United States
(12) Patent Application Publication
(10) Pub. No.: US 2015/0135125 A1
(43) Pub. Date: May 14, 2015

(54) BUBBLE LOUPES

(71) Applicant: Apple Inc., Cupertino, CA (US)

(72) Inventor: Nikhil Mahesh Bhatt, Cupertino, CA (US)

(73) Assignee: Apple Inc., Cupertino, CA (US)

(21) Appl. No.: 14/077,393

(22) Filed: Nov. 12, 2013

(51) Int. Cl. G06F 3/0484

(52) U.S. Cl. CPC G06F 3/04845
USPC 715/781

(57) ABSTRACT

Bubble loupes may be displayed over a portion of a display screen to magnify a region of the display screen. Users may select a region of an image to be displayed as a magnified view on the display screen as a bubble loupe, which automatically resizes and repositions as size and position of the image changes. In this way, bubble loupes may be used to view selected regions of the image at higher or lower levels of magnification simultaneously with the remainder of the image displayed on the display screen. Bubble loupes remains associated with the selected region of the image for which the bubble loupe is displayed. Bubble loupes are stored in association with the image, such that existing bubble loupes associated with the image prior to closing the image will be displayed after a subsequent closing and reopening of the image.

### TECHNICAL FIELD

This application relates generally to viewing magnified visual information on a display screen using bubble loupes.

### BACKGROUND

Information may be displayed on a screen at various levels of magnification. For example, various display screen magnification functionalities are controllable by a user to magnify selected portions of a desktop, including portions of windows open on the screen. The magnifier is often controllable through use of a user input device. In general, such magnifiers show a magnified copy of a portion of what appears on the display screen. Such functionalities have been provided as features within particular application software and as specialty software intended to provide magnification or zoom functionalities generally available for use at an operating system (e.g., desktop) level and with user applications.

Magnification and zoom functionalities are useful within applications, and at the operating system level, to enlarge portions of various screen objects or images. Images may be magnified with a digital loupe, a free-floating magnifier that may be moved over a display screen to view images at higher magnification levels. Electronic forms including one or more fields used to collect or present data to users may be presented with a magnifier that magnifies a portion of the form and allows the user to provide input to the form or view content that had previously been created. The magnifier may further be reoriented to different fields, repositioning and/or resizing to provide different magnified views of the form. Web pages in a browser may be presented in a split view by simultaneously displaying in an overview window a portion of the web page at a first scale factor, and displaying in a magnified-view window a sub-part of the portion of the web page shown in the overview window at a second scale factor. The second scale factor causes visual information of the web page to appear larger in the magnified-view window than in the overview window.

### BRIEF DESCRIPTION OF THE DRAWINGS

Some embodiments are illustrated by way of example and not limitation in the figures of the accompanying drawings in which:

FIGS. 1A-1B depict illustrations of a display screen showing a bubble loupe according to an example embodiment

FIGS. 2A-2B depict illustrations of a display screen showing bubble loupes according to another example embodiment

FIG. 3 is a flowchart illustrating an example method for providing a persistent bubble loupe.

FIG. 4 is a flowchart illustrating another example method for providing a persistent bubble loupe.

FIG. 5 is a diagrammatic representation of a machine in the example form of a computer system within which a set of instructions for causing the machine to perform any one or more of the methodologies discussed herein may be executed.

### DETAILED DESCRIPTION

The following detailed description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims.

According to various embodiments, bubble loupes are displayed to present magnified views of selected regions of visual information on a display screen. A bubble loupe is a graphical user interface element that may be displayed over a portion of a display screen, and which may be used by a user to magnify a region of the display screen. For example, a user may select a region of an image to be displayed as a magnified view on the display screen as a bubble loupe. The bubble loupe may be automatically resized and repositioned as size and position of the image changes. In this way, the user may use the bubble loupe to view the selected region of the image at either a higher or lower level of magnification simultaneously with the remainder of the image displayed on the display screen. Further, the bubble loupe can remain associated with the selected region of the image for which the bubble loupe is displayed. The bubble loupe can be stored in association with the image, in various embodiments, such that existing bubble loupes associated with the image prior to closing the image will be displayed after a subsequent closing and reopening of the image. While numerous examples shall be presented herein involving the use of the bubble loupes in the context of viewing digital images, the bubble loupes may be used in various other contexts. For example, a user may use bubble loupes to magnify a portion of a screen, such as a video displayed by a digital media player, a window displayed by a word processing application, or a web page displayed by a web browser.

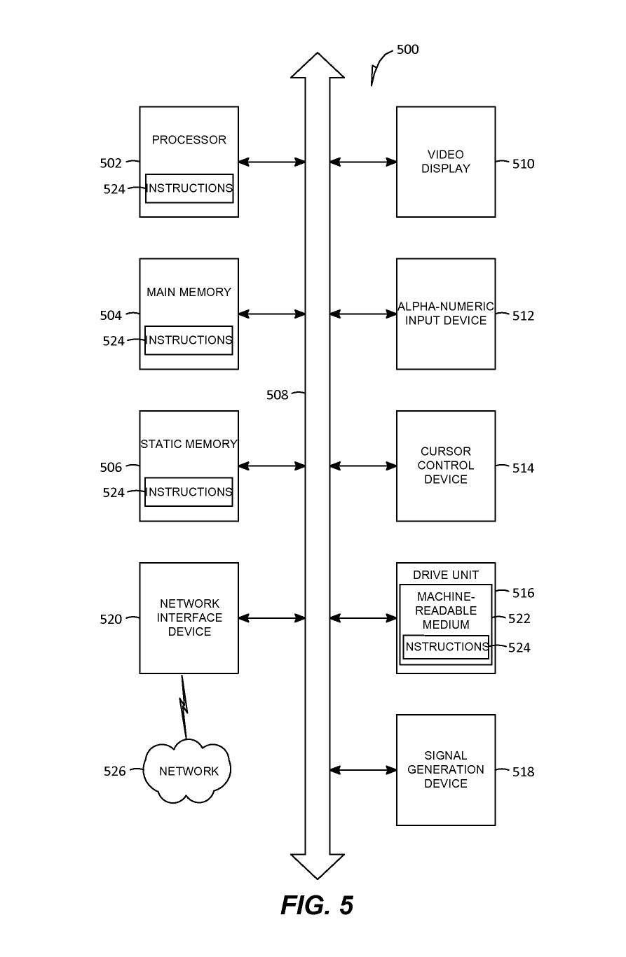

The functionalities of bubble loupes discussed herein may be provided by bubble loupe software modules within an application or an operating system executing on a computer system. A user may interact with the computer system using an input device operationally connected to the computer system. A computer system according to an embodiment of the invention shall be discussed in greater detail below with reference to FIG. 5.

### Positioning of Bubble Loupes

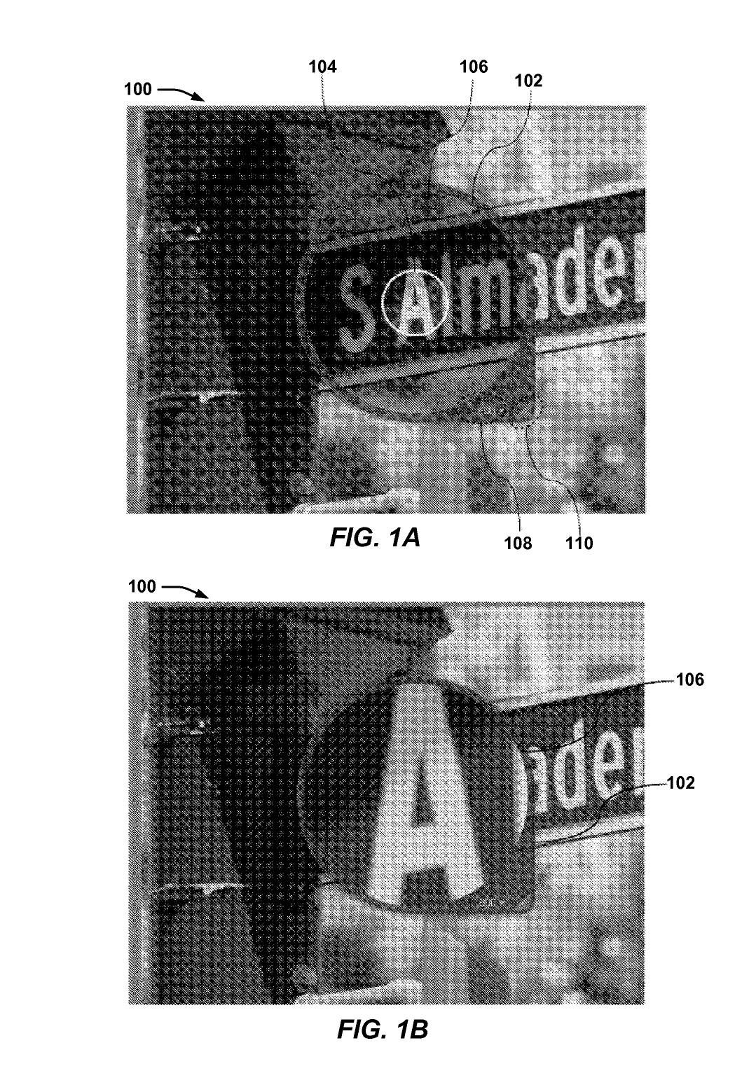

Referring now to the drawings in more detail, FIGS. 1A-1B depict an example illustration of a display screen showing a bubble loupe according to one embodiment. During a positioning state, a digital image 100 can be displayed in a display area of a user interface with a bubble loupe 102 positioned to be centered over a user selected region of the digital image 102, referred to as the target region 104. The bubble loupe 102 comprises: (1) a lens region 106 that encloses a first portion of the digital image 100, the lens region 106 being displayed during the positioning state at a same magnification level as the portion that is displayed outside of the lens region 106, and (2) the target region 104 that encloses a second portion of the digital image 100. The target region 104 is a bounded region approximate to the center of the bubble loupe 102 that visually identifies and corresponds to a particular region of the digital image 102 that will be shown at a magnified level by the bubble loupe 102 during a magnified view state. The portion of the digital image 100 within the target region 104 may be displayed at the same magnification level as the visual that is displayed outside of the lens region 106 (e.g., same as the remainder of the digital image 100) during the positioning state to facilitate positioning of the bubble loupe 102.

The target region 104 of the bubble loupe 102 may be selected for positioning by a user according to a first user input sent by the user through various input mechanisms available to the user (e.g., the user may send the first user input by pressing a button on a keyboard or pressing a mouse button). In an embodiment, this may be accomplished by pressing a mouse button to select the bubble loupe 102, moving the mouse to cause the bubble loupe 102 to be moved in accordance with movement of the mouse pointer, and subsequently release the mouse button to cease causing the bubble loupe 102 to move in accordance with movement of the mouse pointer. For example, the user may press and hold a button on a mouse, with the position of the target region 104 on the display screen moving in accordance with movement of a mouse pointer or other input device, allowing the user to easily move the target region 104 to a desired position. Any movement of the target region 104, in response to movement of the mouse pointer by the user, causes a corresponding movement of the bubble loupe 102 on the display screen, such that the target region 104 remains positioned approximate to the center of the bubble loupe 102. Alternatively, movement of the mouse pointer may move the bubble loupe 102, with a corresponding movement of the target region 104 to remain positioned approximate to the center of the bubble loupe 102.

The user may move either the bubble loupe 102 or the target region 104 such that target region 104 is positioned over a particular region of interest that the user wishes to be displayed as a magnified view. In an embodiment, the target region 104 is visible to the user and appears a circle whose outline is identified using a colored band. The colored band may be displayed with a contrasting color that allows the colored band to be visible to the user (e.g., if the particular region of interest in the digital image 102 bounded by the target region 104 happens to be predominantly black, the colored band may be displayed as white). During the positioning state, the target region 104 may be displayed to be visible to the user regardless of the visual information is being displayed within the lens region 106. Visual information enclosed by the lens region 106 is also visible to the user during movement of the target region 104, such that the user may move target region 104 over the particular region of interest that the user wishes to view at a magnified level.

After the user has finished positioning the target region 104 over the particular region of interest, a magnified view state is entered during which a magnified view of the portion of the digital image 100 enclosed within the target region 104 will be displayed in the lens region 106 of the bubble loupe, as illustrated in FIG. 1B. In an embodiment, the visual information displayed in the lens region 106 during the magnified view state is a magnified view of the portion of the digital image 100 enclosed by the target region 104 during the positioning state. The magnified view is useful for viewing the portion of the digital image 100 selected by the user as the particular region of interest, which is displayed on the display screen at a greater magnification level than the remainder portion of the digital image 100 that is otherwise displayed.

Changing the state of the bubble loupe 102 between the positioning state and the magnified view state allows the bubble loupe 102 to be easily positioned over a desired position by the user, and thereafter the portion of the digital image 100 at the desired position may be displayed at a magnified level relative to the remainder of the digital image 100 displayed outside of the bubble loupe 102. In this manner, the user may view the user selected region (e.g., the target region 104) of the digital image 100 at a magnified level, while still viewing the user selected region in context with the remainder of the digital image 100.

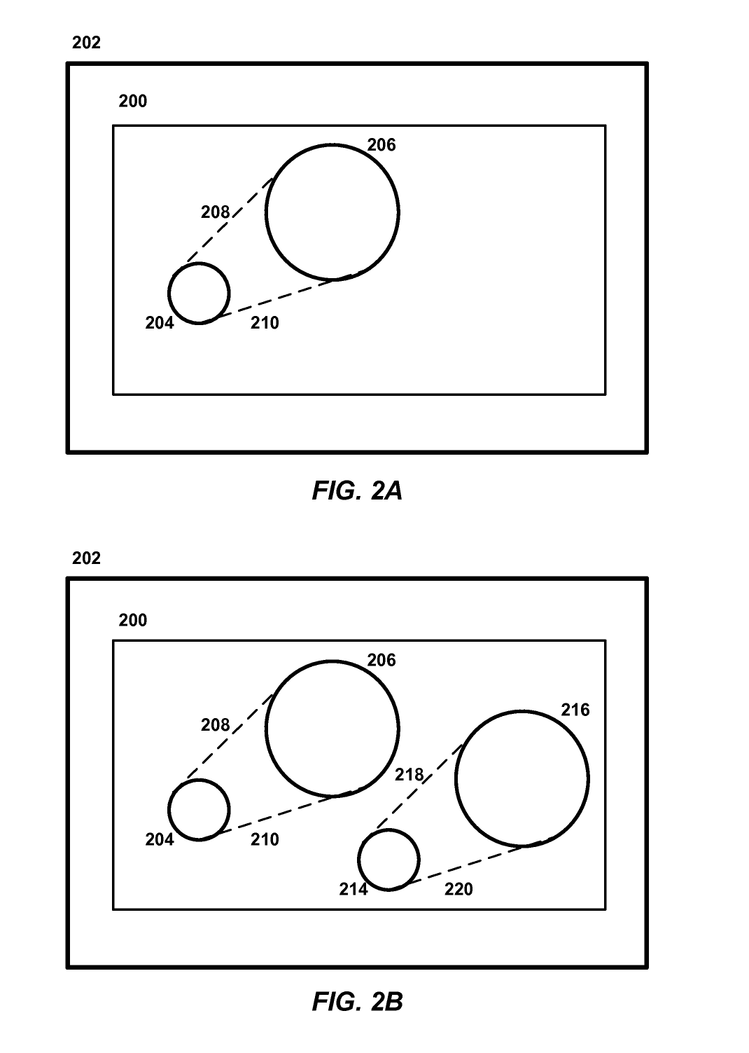

In another embodiment, the bubble loupe may comprise the lens region being displayed offset from the target region, to ensure that display of the lens region and the target region are not obscured. FIG. 2B is an illustration of a bubble loupe according to this alternative embodiment. A digital image 200 is displayed in a user interface of a display screen 202. The bubble loupe comprises a target region 204 and a lens region 206, wherein each of the target region 204 and the lens region 206 may be displayed as a bounded area on the display screen 202. Visual information of the digital image 200 that is identified by the target region 204 is displayed within the lens region 206. Target region 204 may identify visual information in a particular region of interest by pointing to the visual information or by enclosing the visual information within the target region 204.

The bubble loupe includes line 208 and line 210 that connect the target region 204 to the lens region 206. Line 208 and line 210 may either be opaque, transparent, or alpha-blended. The area bounded by line 208, line 210, target region 204, and lens region 206 may similarly be opaque, transparent, or alpha-blended. In a particular embodiment, line 208 and line 210 may be transparent, and the area bounded by line 208, line 210, target region 204, and lens region 206 may be transparent, to advantageously allow visual information identified by target area 204 to be displayed in lens region 206 in a manner that minimizes the amount that display screen 202 is obscured.

Target region 204 and lens region 206 may both be of any shape and size, including circular as illustrated in FIG. 2A. In one embodiment of the invention, target region 204 and lens region 206 are the same shape. In another embodiment of the invention, target region 204 and lens region 206 are a different shape. Target region 204 and lens region 206 may each have either an opaque border, transparent border, or an alpha-blended border. An object that is alpha-blended, as used herein, is displayed such that is partially transparent.

In one embodiment of the invention, target region 204 may be implemented such that target region 204 outlines the area to be viewed in lens region 206 without obscuring the area, such as a circle with an opaque border and a transparent center. In another embodiment, target region 204 is implemented using a movable visual indicator (e.g., an arrow or a crosshair). The visual information identified by target region 204 would, at least in part, be obscured by the movable visual indicator, unless the movable visual indicator is alpha-blended. Thus, in such an embodiment, it is advantageous to make the movable visual indicator partially transparent through the use of alpha-blending.

Various embodiments as disclosed herein may employ any number of bubble loupes. While the examples and figures previously discussed have been directed towards the use of a single bubble loupe, one of ordinary skill in the art would recognize that any number of bubble loupes may be displayed upon a single screen. Such embodiments may be advantageous, as a user may display a bubble loupe for each of two or more distinct regions of visual information (e.g., a user may wish to display a separate bubble loupe for each of two or more digital images that are presented on a display screen). FIG. 2B is an illustration of an embodiment employing multiple bubble loupes, with a separate bubble loupe for two separate regions of the digital image 200 presented on the display screen 202. A first bubble loupe is comprised of the elements: target region 204, lens region 206, line 208, and line 210. A second bubble loupe is comprised of the elements: target region 214, lens region 216, line 218, and line 220.

### Changing Magnification Levels

Referring back to FIGS. 1A-1B, when the bubble loupe 102 is in the magnified view state (as illustrated in FIG. 1B), a magnification level at which the portion of the digital image 100 enclosed by the target region 104 is displayed in the lens region 106 of the bubble loupe 102 may be changed. The magnification level may also be referred to as a scale factor. In an embodiment, a current magnification level may be displayed at location 108 on the bubble loupe 102. In another embodiment, when the magnification level at which the bubble loupe 102 displays the portion of the digital image 100 enclosed by the target region 104 is changing, the current magnification level may be displayed in a more visually prominent location, such as a location within either the target region 104 or the lens region 106 (not shown).

In an embodiment, controls for changing the magnification level may be implemented using any graphical component that allows a user to select the control (e.g., by clicking on the control). Accordingly, the control may be implemented using any mechanism for receiving user input, such as one or more sequences of keystrokes or one or more mouse clicks. For example, a particular magnification level may be chosen from a menu provided by the bubble loupe 102. The user may maneuver a mouse cursor to select a pull down menu available from the bubble loupe 102, and from the menu, the user may be able to select from a variety of magnification levels (not shown). For example, the menu may allow the user to choose from a predetermined set of magnification levels ranging from an original image resolution of 100% to 1600% (these values are merely provided for exemplary purposes, as any set of magnification levels may be predetermined and presented in the menu). The menu need not be displayed on the bubble loupe 102, but rather, may be displayed anywhere on the display screen visible to the user (e.g., the control may be displayed on a toolbar).

In another embodiment, rather than choosing from a set of discrete magnification levels from a menu, the user may zoom in and out using a scroll wheel of a mouse. For example, when the user scrolls a first direction on the scroll wheel of the mouse, the magnification level gradually increases, and when the user scrolls the opposite direction on the scroll wheel, the magnification level gradually decreases, or vice versa.

When the magnification level of a bubble loupe is changed, the process may be performed in a manner that allows the user to visualize changes in the magnification level by providing an animation transitioning from the current magnification level to a new magnification level. In other words, in order to avoid confusing the user by changing the visual information displayed in lens region 106 instantaneously when the magnification level is changed, the change in the magnification level may occur over a noticeable period of time to allow the user to fully comprehend by watching a gradual change in magnification level on the display screen. For example, one or more intermediate magnification levels between the current magnification level and the new magnification level may be displayed as the display transitions to the magnified view state with the new magnification level.

### Bubble Loupe Sizes and Shapes

The bubble loupe 102 may be displayed at any size or shape, and further may be resized or reshaped to any of a plurality of sizes and shapes. In an embodiment, the size of the bubble loupe 102 may be dynamically changed in response to receiving input from the user. For example, in response to receiving user input, the size of the lens region 106 may be changed from a first size to a second size through a series of one or more intermediate sizes. In this way, the changing of the size of the bubble loupe 102 may be intuitively displayed to the user.

In an embodiment, the target region 104 may change in size in proportion to the change in size of the lens region 106. As the lens region 106 and the target region 104 may share the same center point, during the changing of size of the bubble loupe 102, the center point of the lens region 106 and the target region 104 does not move. This is advantageous in some embodiments, as the portion of the digital image 100 enclosed by the target region 104 and displayed in the lens region 106 does not lose focus, and visual continuity is maintained to the user during the resizing of the bubble loupe 102. During the process of updating the display of the bubble loupe 102 to a new size, the portion of the digital image 100 enclosed by the target region 104 may be depicted at a same level of magnification during the changing of the size of the bubble loupe 102 as visual information enclosed in the lens region 106.

In an embodiment, the size of the bubble loupe 102 may be changed by a user selecting the bubble loupe 102, and subsequently moving the mouse in a direction to indicate whether the size of the bubble loupe 102 should increase or decrease. For example, the user may select the bubble loupe 102 using a mouse at a size control 110, as shown on FIG. 1A. Once the size control 110 is selected, moving the mouse in one direction causes the size of the bubble loupe 102 to increase, and moving the mouse in the other direction causes the size of the bubble loupe 102 to decrease.

The display of the size control 110 may dynamically change as the size of the bubble loupe 102 changes. As the size of the bubble loupe 102 decreases, the amount of available space on the bubble loupe 102 to display the size control 110 decreases. As a result, as the amount of available space on the bubble loupe 102 decreases when the size of the bubble loupe 102 decreases, the display of the size control 110 may be updated so that the visual appearance of the size control 110 becomes smaller or less complex. For example, as shown in FIG. 1A, the size control 110 includes a set of three lines. As the size of the bubble loupe 102 decreases, the number and/or the size of the lines included in the size control 110 may decrease. Similarly, as the amount of available space on the bubble loupe 102 increases when the size of the bubble loupe 102 increases, the display of the size control 110 may be updated so that the visual appearance of the size control 110 becomes larger or more complex.

### Persistence of Bubble Loupes

Digital images displayed on the display screen are stored in storage. Storage may be implemented using any mechanism for storing digital images, e.g., a database, file server, volatile memory, or non-volatile memory. A digital image stored in storage has a file image resolution, which is the resolution of the digital image when it is stored. Digital images may be displayed at a different level of resolution than that of the file image resolution, e.g., a particular image may be shown at any magnified resolution level (hereinafter, “magnification level”). The level of resolution of a displayed image shall be referred to as the image resolution. In other words, the term “file image resolution” refers to the resolution of the image as it is stored, and the term “image resolution” refers to the resolution of the image as it is displayed. Digital images may be displayed based on metadata stored along with the digital images in storage. The metadata stored in storage for each digital image can include a parameter set containing information for storing bubble loupe data in association with each digital image.

In an embodiment, bubble loupe data for individual bubble loupes is retained in metadata and stored in storage in association with each individual digital image. Bubble loupe data may be stored in a database, inside the image (e.g., as image metadata), or as a separate file containing only bubble loupe data. Bubble loupe data includes at least location data identifying the specific locations at which individual bubble loupes are displayed and magnification data identifying the magnification levels at which visual information is rendered within individual bubble loupes relative to a reference resolution of the digital images. The reference resolution is generally the original size and resolution of the file image resolution, but bubble loupes may be stored relative to any other reference. In this way, bubble loupes persist in storage along with the digital image. Further, the bubble loupe data may include bubble loupe sizes, center positions for each bubble loupe, zoom factors associated with bubble loupes, and any other parameter that may be used for the displaying of bubble loupes.

For example, referring now to FIG. 2B, the digital image 200 is stored in storage in association with bubble loupe data regarding a display state (e.g., hidden or displayed) for each of the two bubble loupes, information regarding the portion of the digital image 200 that is being magnified (e.g., location of target region 204), and the magnification levels for the display of a magnified view within lens region 206. Information regarding the portion of the digital image 200 that is being magnified may include a set of all pixels contained within the portion of the digital image 200 that is being magnified or a set of boundary pixels defining a boundary, with a bounded portion being enclosed by the boundary being the portion of the digital image 200 that is being magnified.

In an embodiment, the bubble loupe data being associated with a particular digital image causes the loupe data to become a part of the particular digital image's metadata. This metadata is persistently recorded in storage, with the bubble loupes being displayed upon any subsequent opening of the particular digital image for viewing. The stored bubble loupe data can be image-specific, such that opening a different digital image will not cause the display of bubble loupes, even if visual information contained within the particular digital image and the different digital image files are identical. Further, the particular digital image (including its associated metadata) may be shared amongst, and causing the display of bubble loupes, multiple computer systems. In certain embodiments, metadata associated with bubble loupes can be shared amongst multiple images; this may be particularly useful in dealing with images all derived from a common image, such as different versions of an original source image.

In another embodiment, the persistence of bubble loupes to specific regions of a digital image allows for an annotation feature. Bubble loupes may be tagged with a notation to be included in storage with the digital image metadata. The notation may be displayed proximate to its associated bubble loupe, or may be presented for display in a separate display area on the display screen.

### Hiding or Summoning of Bubble Loupes

In an embodiment, the user may cause the bubble loupe 102 to cease to be displayed on the display screen. In such an embodiment, in response to receiving user input to cease displaying the bubble loupe 102 on the display screen, data is maintained that identifies a location where the bubble loupe 102 was previously displayed on the display screen (as described above). The previously displayed bubble loupe 102 is now a hidden bubble loupe, with its location data persisting in storage. Bubble loupes may either be individually selected to be hidden or a hide command may be provided as user input to hide all bubble loupes currently displayed (e.g., all bubble loupes being visible in a digital image). In this way, in response to receiving a subsequent user input requesting the hidden bubble loupe to be displayed on the display screen, the bubble loupe 102 may be displayed in the same position the bubble loupe 102 previously occupied on the display screen prior to the bubble loupe 102 ceasing to being displayed.

As the bubble loupe 102 may be moved to any position on a screen, when the bubble loupe 102 is redisplayed on a screen, it may not be immediately apparent to the user where the bubble loupe 102 is positioned on the screen. Advantageously, embodiments of the invention may support a summon feature, which provides for displaying the bubble loupe 102 if it is not currently being displayed, and moving the bubble loupe 102 to back to the location where the bubble loupe 102 was previously displayed on the display screen 102. In response to receiving a summon user input to re-display the bubble loupe 102, loupe software may cause the display of the bubble loupe 102 to be automatically moved on the display screen, through a series of intermediate positions arranged in a line, from an initial bubble loupe originating position to the location where the bubble loupe 102 was previously displayed on the display screen 102. Alternatively, the bubble loupe 102 may simply appear at the location where the bubble loupe 102 was previously displayed on the display screen, without any movement or display of intermediate positions.

Generally, the summon feature re-displays all previously hidden bubble loupes, but the selective summoning of individual, previously displayed bubble loupes (e.g., bubble loupe 102) may be possible if a specific summon command is provided for each individual bubble loupe. Individual bubble loupes may be stored as a different element in separate layers of the digital image. In certain embodiments, the user may press and hold a series of button on a keyboard to summon a hidden bubble loupe. For example, with an exemplary summon command of pressing “CTRL+NUM”, the pressing of “CTRL+1” and “CTRL+2” would summon two different hidden bubble loupes to be re-displayed on the display screen. Alternatively, a separate region of the display screen may be reserved to display a palette of bubble loupe representations. Selection of individual bubble loupe representations within the palette allows for selective hiding and summoning of bubble loupes.

In another embodiment, the summon feature provides for displaying a new bubble loupe that was not previously displayed on the display screen, and moving the new bubble loupe to a position identified by the user. In response to receiving user input to display a new bubble loupe on the display screen, loupe software may cause the display of the new bubble loupe to be automatically moved on the display screen, through a series of intermediate positions arranged in a line, from an initial bubble loupe originating position to an end position. For example, the end position may correspond to the position identified by the user (e.g., selected by a mouse pointer). Alternatively, the new bubble loupe may simply appear at the position identified by the user, without any movement or display of intermediate positions.

The series of intermediate positions through which the bubble loupes moves through are determined based upon the initial bubble loupe originating position and the end position, identified by the user, of the bubble loupe and are not determined based on movement of the mouse pointer. For example, in one embodiment, to use the summon feature, the user may press and hold a button on the keyboard. In response, if the bubble loupe 102 is currently a hidden bubble loupe that is not currently displayed on the display screen, then it is re-displayed on the display screen at the last position in which the bubble loupe 102 was displayed. While the bubble loupe 102 is moving across the display screen to the location where the bubble loupe 102 was previously displayed on the display screen, no additional user input or movement from the mouse is necessary. Alternatively, a new bubble loupe being summoned will be moved across the display screen to a position occupied by the mouse pointer. While the new bubble loupe is moving across the display screen to the position occupied by the mouse pointer, no additional input or movement from the mouse is necessary for the new bubble loupe to be moved to the current position of the mouse pointer on the display screen. In another embodiment, each time a new bubble loupe is displayed on the display screen, the new bubble loupe may be displayed at the same position on the display screen at a default location, and must be manually moved by the user to a desired location on the display screen.

In an embodiment, the user may send user input to request a performance of the summon feature by pressing and holding a certain button. Merely pressing the same button, but without holding the button for an extended duration, may cause the bubble loupe 102 to cease being displayed on the display screen if it is currently being displayed or cause the bubble loupe 102 to be redisplayed on screen at the position at which it was last displayed if the bubble loupe 102 is not currently being displayed. In this way, the same button may be used by the user to request a performance of the summon feature and toggle the display of the bubble loupe 102 on the display screen.

### Automatic Resizing and Repositioning of the Bubble Loupes

As previously discussed, visual information of digital images may be displayed on a display screen at various levels of magnification within different bubble loupes. For example, the bubble loupe 102 may display visual information of the digital image 100 within the lens region 106 at a higher magnification level relative to the original resolution of the digital image (e.g., at 200% magnification). A second bubble loupe (e.g., illustrated in FIG. 2B) may display visual information from a second portion of the digital image 100 within a second lens region at a different magnification level. For example, a digital image on the display screen may display multiple bubble loupes, each at a different magnification level and resolution relative to the original resolution of the digital image, while simultaneously displaying the digital image at its original resolution (e.g., each pixel of the screen may correspond to a pixel of the digital image).

Bubble loupes resize and reposition automatically as the digital image with which they are associate changes size and position, such that the bubble loupes follow the portions of the digital image to which they are applied and present visual information at the same magnification level. For example, a digital image may be displayed at its original resolution with two bubble loupes positioned over two specific portions of the digital image. In an embodiment, if the position of the digital image is shifted on a display screen or moved to a different display screen, the bubble loupes will reposition such that remain positioned over the two specific portions of the digital image, even after the digital image has been moved. In another embodiment, the position of the digital image remains the same, but the display size of the entire digital image may be changed (e.g., from the original resolution to, for example, 200% magnification) and visual information within the digital image will be displayed in accordance with the new display size. Display of the bubble loupes will dynamically change in response to changes in the size of the digital image, such that the bubble loupes will move to remain positioned over the two specific portions of the digital image, and further, the bubble loupes will become enlarged such that the two specific portions of the digital image remain magnified within the bubble loupes at their same, respective scale factors/magnification levels as prior to the digital image display size change. Similarly, if the digital image is changed to be displayed at a reduced resolution or magnification level, the position and sizes of the bubble loupes will dynamically change to be a decreased size. The same approximate region of the digital image would be displayed as magnified, however, by maintaining the same magnification level/scale factor, the displayed size of the bubble loupes must change as well.

### Adjustments to Displayed Image

In an embodiment, prior to requesting a change that effects the appearance of visual information displayed on the display screen, the change may initially be previewed with the bubble loupe 102. For example, a user might wish to change the luminance value of each pixel of the digital image 100 in a certain manner. Such a change requires a certain amount of processing resources to effect the change across the entire digital image.

If the bubble loupe 102 is positioned over a portion of the digital image, then embodiments of the invention allow for just rendering of the pixels enclosed by the lens region 106 of the bubble loupe 102 to reflect the change prior to effecting the change across the entire digital image (e.g., the bubble loupe 102 may be in the magnified view mode, thereby providing a magnified view of the result of the requested change). In response to receiving user input that accepts the requested change, the requested change may then be made to the remainder of the digital image 100. In this way, the processing required to effect the change across the entire digital image 100 may be postponed until the user verifies the requested change, thereby avoiding the expenditure of resources to effect the change across the entire intended area until the expenditure of such resources have been verified as being worthwhile. When image areas containing multiple bubble loupes are adjusted, requested changes across multiple bubble loupes (which may include different changes) may be rendered first in the bubble loupes prior to applying the requested changes across the entire digital image 100. In a similar manner, a requested change as rendered for preview in a single bubble loupe (e.g., the bubble loupe 102) may be selectively applied to only the portion of the digital image 100 enclosed by the lens region 106.

Alternatively, rendering of the digital image 100 may take precedence, with requested changes displayed first to the digital image 100. In response to receiving user input that accepts the requested change, the requested change may then be applied and rendered to be displayed in the lens region 106. In this way, bubble loupes are rendered after the digital image 100, which provides an A/B testing functionality in which proposed changes may be first previewed in the context of the original resolution of the digital image 100, and updating the lens region 106 with the requested change for finer detail control at a higher magnification level after the requested change has been verified by the user.

### Example Methods

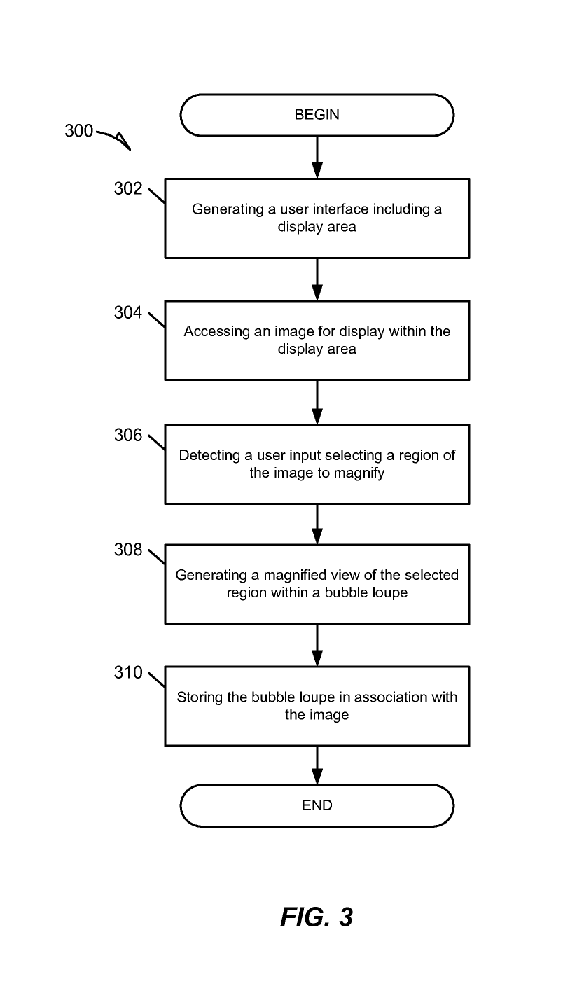

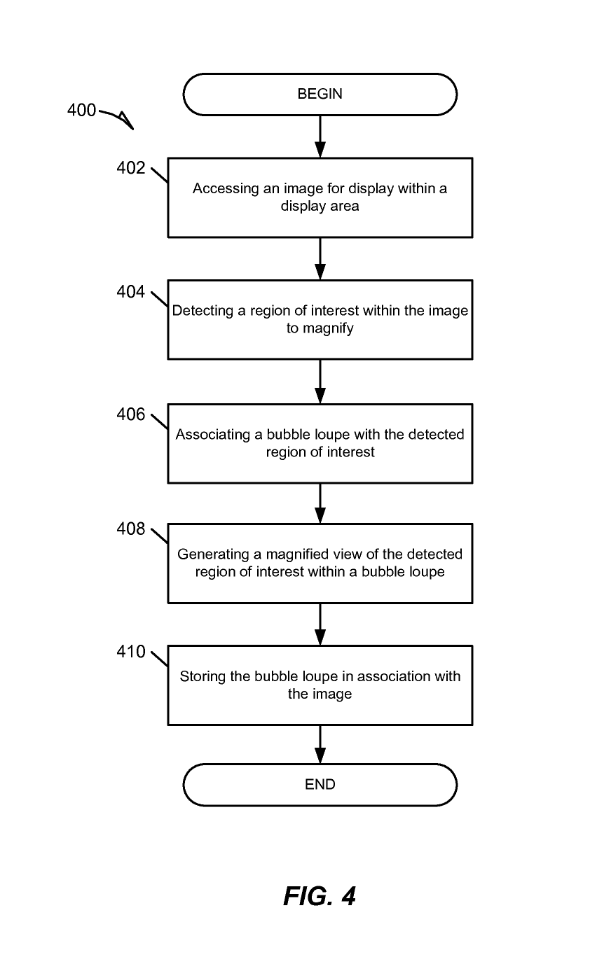

Additional details regarding the above functionalities provided by the bubble loupes are detailed below in reference to FIGS. 3 and 4.

FIG. 3 is a flowchart illustrating an example method 300 for providing a persistent bubble loupe. In an embodiment, the method 300 can include operations such as: generating a user interface at 302, accessing an image at 304, detecting a user input at 306, generating a magnified view at 308, and storing a bubble loupe at 310.

At block 302, method 300 begins by generating a user interface including a display area to display a digital image. At block 304, method 300 continues by accessing the image for display within the display area. For example, digital images may be accessed from storage to be displayed upon a graphical user interface of a computer system. In some embodiments, digital images may be accessed from other sources, such as an attachment to an email or viewed through a web browser. At block 306, method 300 continues by detecting a user input selecting a region of the digital image to magnify. As previously discussed, various mechanisms are disclosed for positioning elements of a bubble loupe, including the target region or lens region, over a region of digital images that the user desires to magnify. The user input of selecting a region of the digital image to magnify may cause a bubble loupe to be associated with the region and persistently stored as metadata. At block 308, method 300 continues by generating a magnified view of the selected region for display within the bubble loupe. The magnified view may be displayed at a default magnification level, which is modifiable by the user to change magnification levels at which visual information is displayed in the bubble loupe. At block 310, method 300 concludes by storing the bubble loupe in association with the image. The bubble loupe data being stored in association with the digital image causes the bubble loupe to become a part of the digital image's metadata. This metadata is persistently recorded in storage, with the bubble loupe being displayed upon a subsequent opening of the digital image for viewing by a software application that supports bubble loupe functionalities.

FIG. 4 is a flowchart illustrating another example method 400 for providing a persistent bubble loupe. At block 402, the method 400 begins by accessing an image for display within a display area. For example, digital images may be accessed from storage to be displayed upon a graphical user interface of a computer system. In some embodiments, digital images may be accessed from other sources, such as an attachment to an email or viewed through a web browser. At block 404, the method 400 continues by detecting a region of interest within the image to magnify.

In an embodiment, the detecting may include the identifying of a set of image characteristics that the user desires to magnify for further image processing. This may include the detection of a particular shadow detail, a bright area, a background object, a distortion, an artifact, or any other quantifiable image characteristic. In another embodiment, the detecting may include detecting the presence and location of a face or a face element. For example, facial features such as the presence of an eye, an ear, a nose, or a mouth may be detected. Further, the detecting may include a combination of facial features and quantifiable image characteristics. For example, the detecting may include detecting a specific skin tone.

At block 406, the method 400 continues by associating a bubble loupe with the detected region of interest. This includes defining both a bounded area within the digital image wherein the detected region of interest is detected and assigning a default magnification level at which visual information representing the detected region of interest is displayed. In an embodiment, when multiple regions of interest are detected in close proximity to each other, a single bubble loupe may be associated with a region of the image encompassing the multiple regions of interest. In another embodiment, separate bubble loupes may be associated with each of the multiple regions of interest. Alternatively, a determination may be made regarding the image characteristics detected to determine whether a single bubble loupe is sized and positioned to be associated with multiple regions of interest. For example, if two detected regions of interest are similar facial features (e.g., each region of interest being one of a pair of eyes or eyebrows), then a single bubble loupe may be associated with the two detected regions of interest. If the two detected regions of interest are close in proximity but do not share any similar image characteristics (e.g., detected eye positioned near a detected shadow), then separate bubble loupes may be associated with each of the two detected regions of interest.

At block 408, the method 400 continues by generating a magnified view of the detected region of interest for display within the bubble loupe. The magnified view may be displayed at the default magnification level, which is modifiable by the user to change magnification levels at which visual information is displayed in the bubble loupe. At block 410, the method 400 concludes by storing the bubble loupe in association with the image. The bubble loupe data being stored in association with the digital image causes the bubble loupe to become a part of the digital image's metadata. This metadata is persistently recorded in storage, with the bubble loupe being displayed upon any subsequent opening of the digital image for viewing.

One of ordinary skill in the art would understand that while the above methods for providing a bubble loupe are described only in the context of a single bubble loupe, the methods may be repeated any number of times to display multiple bubble loupes on a single digital image. Further one of ordinary skill in the art would recognize that bubble loupes may also be removed from display on the digital image, including a deletion of a bubble loupe wherein the deleted bubble loupe is no longer associated with the digital image and a hiding function wherein the bubble loupe is removed from display but remains associated with the digital image.

Though arranged serially in the examples of FIGS. 3 and 4, other examples may reorder the operations, omit one or more operations, and/or execute two or more operations in parallel using multiple processors or a single processor organized as two or more virtual machines or sub-processors. Moreover, still other examples can implement the operations as one or more specific interconnected hardware or integrated circuit modules with related control and data signals communicated between and through the modules. Thus, any process flow is applicable to software, firmware, hardware, and hybrid implementations.

### Example Machine Architecture and Machine-Readable Medium

The bubble loupes described herein may be implemented by bubble loupe software, which may be comprised within an application or an operating system executing on a computer system. FIG. 5 is a block diagram of a machine in the example form of a computer system 500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

### Machine-Readable Medium

The disk drive unit 516 includes a machine-readable medium 522 on which is stored one or more sets of instructions and data structures (e.g., software) 524 embodying or used by any one or more of the methodologies or functions described herein. The instructions 524 may also reside, completely or at least partially, within the main memory 504, static memory 506, and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing or encoding data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks. All such machine readable storage media are hardware devices suitable for storing data and/or instructions for a suitable period of time to enable use by the machine, and are therefore non-transitory.

### Transmission Medium

The instructions 524 may further be transmitted or received over a communications network 526 using a transmission medium. The instructions 524 may be transmitted using the network interface device 520 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method for providing a persistent magnified image region within an image, the method comprising:
generating a user interface including a display area to display an image;
accessing the image for display within the display area;
detecting a first user input selecting a first target region of the image to magnify;
associating, in response to detecting the first user input, a first graphical user interface element with the first target region;
generating a magnified view of the first target region for display within the first graphical user interface element, the magnified view including at least a portion of the first target region; and
storing a parameter set describing the first graphical user interface element in association with the image.

2. The method of claim 1, further comprising:
receiving a second user input closing the image;
receiving, subsequent to closing the image, a third user input reopening the image; and
regenerating, in response to reopening the image, the first graphical user interface element according to the parameter set.

3. The method of claim 1, wherein the first graphical user interface element is displayed offset from the first region.

4. The method of claim 1, further comprising:
detecting a second user input selecting a second region of the image to magnify;
associating, in response to detecting the second user input, a second graphical user interface element with the second region;
generating a second magnified view of the second region for display within the second graphical user interface element, the second magnified view including at least a portion of the second region; and
storing a second parameter set defining the second graphical user interface element in association with the image, the second parameter set including a relative location of the second region within the image and a magnification setting.

5. The method of claim 4, wherein the second graphical user interface element is displayed offset from the second region.

6. The method of claim 1, wherein the first graphical user interface element resizes and repositions automatically as the image changes size and position.

7. The method of claim 1, further comprising:
detecting a third user input to hide the first graphical user interface element; and
removing the first graphical user interface element from display, wherein the first graphical user interface element remains associated with the first target region.

8. The method of claim 1, wherein the first graphical user interface element further comprises a second display area for entering an annotation associated with the magnified view of the image.

9. The method of claim 1, wherein the parameter set includes a plurality of pixels defining a boundary of the first region within the image and a magnification setting for the display of the magnified view of the first region.

10. A method of displaying at least one magnified image portion of an image, the method comprising:
displaying the image in a display area of a user interface;
detecting a first region of interest within the image to magnify;
associating, in response to detecting the first region of interest, a first graphical user interface element with the first region of interest;
displaying the first graphical user interface element, wherein the first graphical user interface element comprises a first display area for displaying magnified depictions;
displaying the at least one magnified image portion within the first display area, wherein the at least one magnified image portion is a magnified depiction of the detected first region of interest; and
storing a parameter set defining the first graphical user interface element in association with the image, the parameter set including a relative location of the first region of interest within the image and a magnification setting.

11. The method of claim 10, wherein the detecting the first region of interest comprises identifying at least one of a set of image characteristics.

12. The method of claim 11, wherein the at least one of a set of image characteristics comprises at least one of a shadow detail, a bright area, a background object, a distortion, and an artifact.

13. The method of claim 10, wherein the detecting a first region of interest comprises detecting the presence and location of a face.

14. The method of claim 10, wherein the first graphical user interface element is displayed offset from the first detected region of interest.

15. The method of claim 10, further comprising:
detecting a second region of interest within the image to magnify;
associating, in response to detecting the second region of interest, a second graphical user interface element with the detected second region of interest;
displaying the second graphical user interface element, wherein the second graphical user interface element comprises a second display area for displaying magnified depictions;
displaying a magnified depiction of the second region of interest within the second display area; and
storing a second parameter set defining the second graphical user interface element in association with the image, the second parameter set including a second relative location of the second region of interest within the image and a second magnification setting.

16. The method of claim 15, wherein the second graphical user interface element is displayed offset from the second region of interest.

17. The method of claim 10, wherein the first graphical user interface element resizes and repositions automatically as the image changes size and position.

18. The method of claim 10, further comprising:
detecting a user input to hide the first graphical user interface element;
removing the first graphical user interface element from display, wherein the parameter set defining the first graphical user interface element remains associated with the image.

19. The method of claim 10, wherein the first graphical user interface element further comprises a second display area for annotating the image.

20. A machine-readable storage device comprising instructions that when executed by at least one processor perform operations comprising:
generating a user interface including a display area to display an image;
accessing the image for display within the display area;
detecting a first user input selecting a first region of the image to magnify;
associating, in response to detecting the first user input, a first graphical user interface element with the first region;
generating a magnified view of the first region for display within the first graphical user interface element, the magnified view including at least a portion of the first region; and
storing a parameter set defining the first graphical user interface element in association with the image, the parameter set including a relative location of the first region within the image and a magnification setting.

21. The machine-readable storage device of claim 15, further comprising instructions that when executed perform operations comprising:
receiving a second user input closing the image;
receiving, subsequent to closing the image, a third user input reopening the image; and
regenerating, in response to reopening the image, the first graphical user interface element according to the parameter set.

22. The machine-readable storage device of claim 15, further comprising instructions that when executed perform operations comprising:
detecting a second user input selecting a second region of the image to magnify;
associating, in response to detecting the second user input, a second graphical user interface element with the second region;
generating a second magnified view of the second region for display within the second graphical user interface element, the second magnified view including at least a portion of the second region; and
storing a parameter set defining the second graphical user interface element in association with the image, the parameter set including a relative location of the second region within the image and a magnification setting.
